(19) United States
(12) Patent Application Publication
(10) Pub. No.: US 2012/0187097 A1
(43) Pub. Date: Jul. 26, 2012

(54) LASER ENGRAVER CAPABLE OF AUTOMATIC DEFOCUSING

(76) Inventors: Jang-Yie WU, Taipei Hsien (TW); Po-Hung LIN, Taipei Hsien (TW)

(21) Appl. No.: 13/013,663

(22) Filed: Jan. 25, 2011

(51) Int. Cl. B23K 26/00

(52) U.S. Cl. 219/121.68

(57) ABSTRACT

A laser engraver capable of automatic defocusing is provided, which includes a control end and a device end. The control end includes a data processing module, in which the data processing module is used for a user to set a defocusing distance and select a processing mode by a user, so as to define and set parameters, and form an operation signal. The device end includes a control module and a laser output module, in which the control module is used for receiving the operation signal and controlling the laser output module to change a focal distance according to the operation signal, so as to form the automatic defocusing.

### BACKGROUND OF THE INVENTION

1. Field of Invention

The present invention relates to a laser engraver capable of automatic defocusing that has a simple structure and improves a processing flow and convenience for a user.

2. Related Art

A using process of a laser engraver is very simple. Just like printing on paper by using a computer and a printer, a pattern can be “printed” into the engraver through the computer so long as the patterns are edited. The only difference lies in that, in printing, ink powder is spread on the paper, while in laser engraving, light rays output by a laser are guided and focused on a surface of an object to be engraved, for example, a wood product, acryl, a plastic board, a metal board, or a stone material. The focused light rays are absorbed by the material, and then a temperature of the material increases suddenly and the material is gasified, such that the surface of the object is recessed, thereby achieving an objective of engraving.

In a focusing method of the current laser engraver, after a through-beam sensor disposed on a table detects the object through lifting of a platform, the sensor is lowered to a focusing plane, and thus an automatic focusing is completed. However, an operation of defocusing still relies on the lifting and lowering of a device controlled by manual labor, which is not convenient and ideal for the user.

### SUMMARY OF THE INVENTION

The present invention is directed to a laser engraver capable of automatic defocusing that has a simple structure and improves a processing flow and convenience of a user.

To achieve the objective, the present invention provides a laser engraver capable of automatic defocusing, which includes a control end and a device end. The control end includes a data processing module, in which the data processing module is used for a user to set a defocusing distance and select a processing mode, so as to define and set parameters, and form an operation signal. The device end includes a control module and a laser output module, in which the control module is used for receiving the operation signal and controlling the laser output module to change a focal distance according to the operation signal, so as to form the automatic defocusing.

In an embodiment, the parameters include a user parameter and a serving software setting parameter.

In an embodiment, the selecting the processing mode is selecting a layer or a processing tool.

In an embodiment, the control module includes a judging module, for judging whether the operation signal instructs an execution of engraving or changing of the focal distance, and the execution of the changing of the focal distance includes the execution of focusing or defocusing.

In an embodiment, the control end is a computer.

To make the present invention more comprehensive, the specific content and the efficacy of the present invention are described in detail hereinafter with reference to the accompanying drawing and drawing number.

### BRIEF DESCRIPTION OF THE DRAWINGS

FIG. 1 is a schematic structural view of components of a laser engraver capable of automatic defocusing according to an embodiment of the present invention.

### DETAILED DESCRIPTION OF THE INVENTION

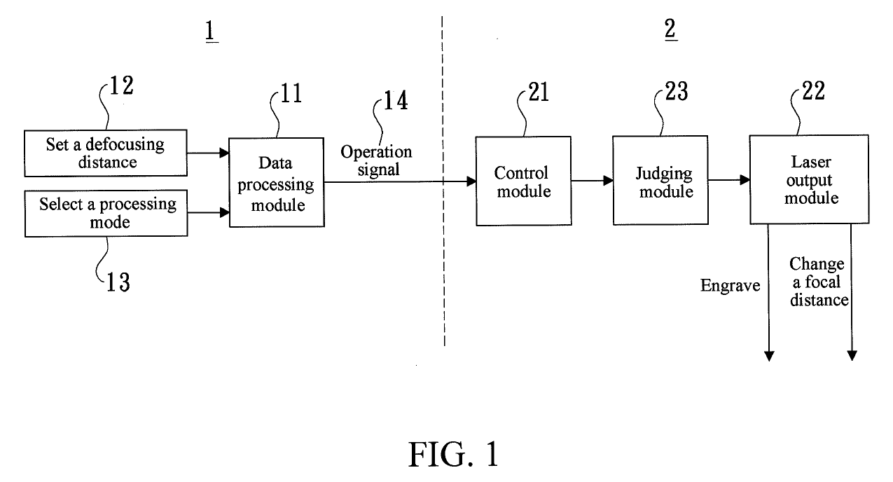

FIG. 1 shows a laser engraver capable of automatic defocusing according to the present invention, which includes a control end 1 and a device end 2.

The control end 1 is a computer, which includes a data processing module 11. The data processing module 11 is used for a user to set a defocusing distance 12 and select a processing mode 13, so as to define and set parameters, and form an operation signal 14, in which the parameters 12 include a user parameter and a serving software setting parameter. The selecting the processing mode 13 is selecting a layer or a processing tool.

The device end 2 includes a control module 21 and a laser output module 22, in which the control module 21 is used for receiving the operation signal 14 and controlling the laser output module 22 to change a focal distance according to the operation signal 14, so as to form automatic defocusing. The control module 21 includes a judging module 23, for judging whether the operation signal 14 instructs an execution of engraving or changing of the focal distance, and the execution of the changing of the focal distance includes the execution of focusing or defocusing.

In the embodiment, referring to FIG. 1, the user first inputs the set defocusing distance 12 and the selected processing mode 13 at the data processing module 11 according to a processing requirement. The data processing module 11 then defines the user parameter and the serving software setting parameter, transmits a document of relevant parameters, finally forms an operation signal 14, and transmits the operation signal 14 to the control module 21 of the device end 2. After the operation signal 14 is received by the control module 21 and judged by the judging module 23, the laser output module 22 is demanded to perform the execution of the engraving or changing of the focal distance.

The above descriptions are the specific embodiment of the present invention and the applied technical solutions. Variations and modifications can be deduced according to the disclosure or teaching of the present invention. Any equivalent variation whose effect does not exceed the actual spirit covered by the specification and drawing shall fall within the scope of the present invention.

According to the content disclosed above, the present invention can achieve the expected objective of providing a laser engraver capable of automatic defocusing, and has industrial utilization and practical values. Therefore, the invention patent application is proposed according to the law.

What is claimed is:

1. A laser engraver capable of automatic defocusing, comprising:
a control end, comprising a data processing module, wherein the data processing module is used for a user to set a defocusing distance or select a processing mode, so as to define and set parameters, and form an operation signal; and
a device end, comprising a control module and a laser output module, wherein the control module is used for receiving the operation signal and controlling the laser output module to change a focal distance according to the operation signal, so as to form automatic defocusing.

2. The laser engraver capable of automatic defocusing according to claim 1, wherein the parameters comprise a user parameter and a serving software setting parameter.

3. The laser engraver capable of automatic defocusing according to claim 1, wherein the selecting the processing module is selecting a layer or a processing tool.

4. The laser engraver capable of automatic defocusing according to claim 1, wherein the control module comprises a judging module for judging whether the operation signal instructs an execution of engraving or changing of the focal distance.

5. The laser engraver capable of automatic defocusing according to claim 4, wherein the execution of the changing of the focal distance comprises the execution of focusing or defocusing.

6. The laser engraver capable of automatic defocusing according to claim 1, wherein the control end is a computer.
